(19) United States
(12) Patent Application Publication
(10) Pub. No.: US 2026/0024399 A1
(43) Pub. Date: Jan. 22, 2026

(54) BET DISPLAY SYSTEM FOR ROULETTE

(71) Applicant: JUMBO TECHNOLOGY CO., LTD., TAICHUNG (TW)

(72) Inventors: Shun Tsung HSU, TAICHUNG (TW); Chang Yi WANG, TAICHUNG (TW)

(21) Appl. No.: 18/776,826

(22) Filed: Jul. 18, 2024

(51) Int. Cl. G07F 17/32; G06T 7/70; H04N 5/265

(52) U.S. Cl. CPC G07F 17/3211; G06T 7/70; G07F 17/3288; H04N 5/265; G06T 2207/20221

(57) ABSTRACT

A bet display system for roulette includes a game processing unit, a game result generating unit, a betting interface, and a game status display screen. The game result generating units generates one of game results. The betting interface is provided for a player to bet to generate a betting data. The game status display screen displays bars which show substantial betting points of the game results equivalently converted from the betting data through different length. The game processing unit performs a numerical range classification on numerical values of the substantial betting points, the substantial betting points are arranged from small to large numerical values and classified to belong to range groups Pi, wherein i is one of 1, 2, . . . , N, N is greater than or equal to 3, and the substantial betting point belonging to the range group PN is shown by the bar with the longest length.

### FIELD OF THE INVENTION

The invention relates to a roulette game, more particularly to a bet display system for roulette.

### BACKGROUND OF THE INVENTION

The roulette game mainly provides a roulette wheel and a colored ball for playing the game. The roulette area is usually divided into 37 areas, which are marked with numbers 0˜36 respectively. The colored ball is thrown into the rotating roulette wheel and rolls along with the roulette wheel. After the roulette wheel stops, the colored ball continues to roll due to inertia until the inertia is exhausted and stops in one of the 37 areas, thereby producing one of 37 game outcomes.

The roulette game has the characteristics of high odds, easy-to-learn rules, and difficulty in cheating, so it is widely popular among players. The roulette game provides a betting interface for players to bet. The betting interface has a plurality of betting areas corresponding to 37 game results. Each of the betting areas corresponds to at least one of the game results, and each of the betting areas has a different payout odds based on the probability of occurrence of the corresponding game result.

Common betting areas comprise single bets (0˜36), column bets (first column˜ third column), dozen bets (first dozen˜ third dozen), even/odd bet, red/black bet, high/low bet (“1 to 18”, “19 to 36”), etc. When the game result corresponding to the betting area that the player bets on occurs in the roulette game, the payout will be based on the payout odds and the player's betting points.

To let the players to grasp how many points will be paid out when the roulette game generates a certain game result, the conventional technology will convert the player's bets on the betting areas into the substantial betting points of the game results respectively, and display them in a graphical representation on the virtual roulette wheel. Therefore, the problem that the player cannot easily grasp how many points will be paid out due to that the game result may correspond to a plurality of betting areas is solved.

However, when the virtual roulette wheel displays the substantial betting points in a graphical representation, especially when the numerical values of the substantial betting points are expressed in the form of displayed length, it is often difficult to quickly judge due to inappropriate scale. For example, if the respective substantial betting points of the game results are too small, the displayed length will also be too short and difficult to interpret. On the contrary, if the respective substantial betting points of the game results are too large, the length will exceed the boundary of the graphical representation, the respective substantial betting points of the game results can only show the same length, and therefore the numerical values of the substantial betting points cannot be judged.

### SUMMARY OF THE INVENTION

A main object of the invention is to disclose a bet display system for roulette capable of graphically displaying a player's substantial betting points for each game result in a roulette game with the most suitable scale.

In order to achieve the above object, the invention discloses a bet display system for roulette which includes a game processing unit, a game result generating unit, a betting interface, and a game status display screen, wherein the game processing unit is connected to the game result generating unit, the betting interface, and the game status display screen. The game processing unit is configured to perform the following step S1, step S2, and Step S3.

Step S1: performing a roulette game, an operation of a roulette game is controlled by generating one of a plurality of game results through the game result generating unit and a roulette image is displayed through the game status display screen.

Step S2: obtaining a betting data, the game processing unit obtains a betting data which is generated by a player betting on a plurality of betting areas within a betting time through the betting interface, wherein each of the plurality of betting areas corresponds to at least one of the plurality of game results; and

Step S3: displaying a plurality of bars, the game status display screen displays a plurality of bars, the plurality of bars show substantial betting points of the plurality of game results through different length, and the substantial betting points are equivalently converted from the betting data. The game processing unit is configured to perform a numerical range classification on numerical values of the substantial betting points of the plurality of game results, so that the substantial betting points of the plurality of game results are arranged from small to large numerical values and classified to belong to a plurality of range groups Pi, wherein i is one of 1, 2, . . . , N, and N is greater than or equal to 3. The substantial betting point belonging to the range group PN is shown by the bar with the longest length.

Accordingly, the invention first performs grouping, so that the substantial betting points of the game results are arranged from small to large numerical values and classified to belong to the range groups Pi, i is one of 1, 2, . . . , N. Therefore, regardless of whether the substantial betting point with the largest value is high or low, the largest substantial betting point will always belong to the range group PN and be presented by the longest bar, and the other substantial betting points will belong to one of the range groups Pi. Thus, there will be no problem that a length of each of the bars is too short and difficult to interpret, or a length is too long to exceed a boundary of the roulette image and cannot be judged due to inappropriate scale.

### BRIEF DESCRIPTION OF THE DRAWINGS

FIG. 1 is a block diagram of a bet display system for roulette of the invention.

FIG. 2 is a schematic diagram of a touch screen according to an embodiment of the invention.

FIG. 3 is a schematic diagram of a game status display screen according to an embodiment of the invention.

FIG. 4 is a flow chart of steps performed by the game processing unit of the invention

FIG. 5 is a schematic diagram of the game status display screen according to another embodiment of the invention.

FIG. 6 is a schematic diagram of the game status display screen according to a further embodiment of the invention.

### DETAILED DESCRIPTION OF THE PREFERRED EMBODIMENTS

The detailed description and technical content of the invention are described below with reference to the accompanying drawings.

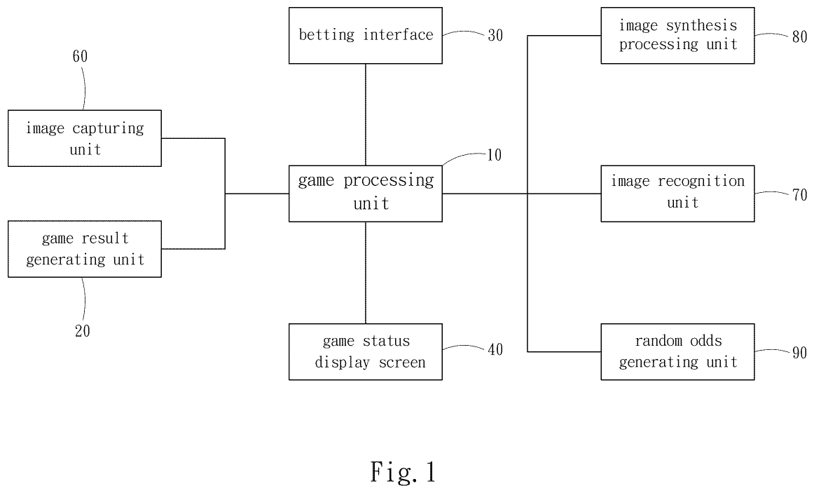

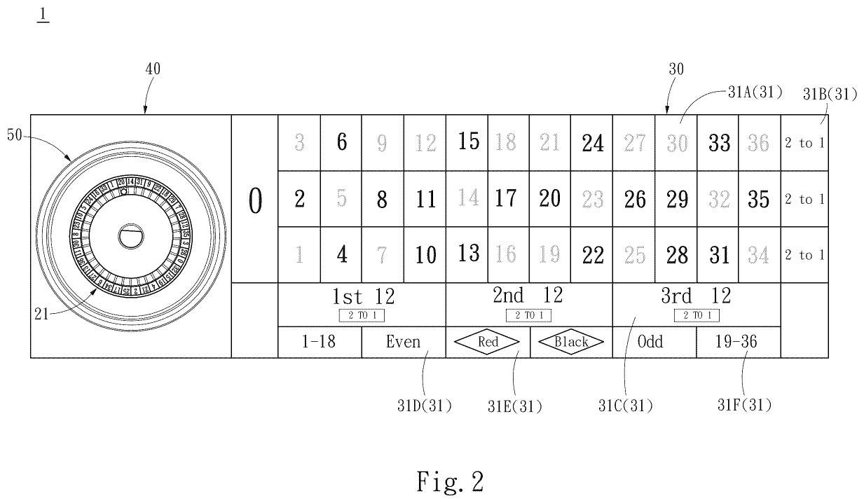

Please refer to FIG. 1 and FIG. 2, the invention provides a bet display system for roulette, which includes a game processing unit 10, a game result generating unit 20, a betting interface 30 and a game status display screen 40. The game processing unit 10 is connected to the game result generating unit 20, the betting interface 30, and the game status display screen 40.

The game processing unit 10 is configured to control an operation of a roulette game for a player to play the roulette game.

The game result generating unit 20 is connected to the game processing unit 10. The game result generating unit 20 has a plurality of game results 21 (for example, numbers 0˜36), and after a betting time of each round of the roulette game ends, the game result generating unit 20 designates one of the game results 21 according to a preset rule and transmits the game result to the game processing unit 10. The game result generating unit 20 can be a physical roulette wheel or a random generator, wherein the random generator is a program code that can be set to randomly designate one of the numbers from 0 to 36.

In one embodiment, the betting interface 30 and the game status display screen 40 are implement in a touch screen 1. The betting interface 30 comprises a plurality of betting areas 31, and each of the plurality of betting areas 31 corresponds to at least one of the plurality of game results 21. In detail, if the game results 21 are the number 0˜36, types of the plurality of betting areas 31 include single bets 31A (“0 to 36”), column bets 31B (first column˜ third column), dozen bets 31C (first dozen˜ third dozen), even/odd bet 31D, red/black bet 31E (in FIG. 2, the lighter gray-scale numbers represent “red numbers”, and the darker gray-scale numbers represent “black numbers”), high/low bet 31F (“low numbers” refers to numbers “1 to 18” and “high numbers” refers to numbers “19 to 36”). For example, when the game result 21 designated by the game result generating unit 20 is “30”, the corresponding betting areas 31 are the individual number “30” of the single bet 31A, “the first column” of the column bet 31B, “the third dozen” of the dozen bet 31C, “the even number” of the even/odd bet 31D, “the red number” of the red/black bet 31E and “high numbers (19 to 36)” of the high/low bet 31F.

The betting interface 30 is provided for the player to bet on the plurality of betting areas 31 within the betting time to generate a betting data, the betting data records a betting amount of each of the betting areas 31, and the betting interface 30 transmits the betting data to the game processing unit 10. After obtaining the betting data, the game processing unit 10 calculates and obtains a substantial betting point of each of the plurality of game results 21 based on the betting amount of the plurality of betting areas 31. In detail, the betting amounts of the plurality of betting areas 31 that are not the single bets 31A, such as the column bets 31B, the dozen bets 31C, the even/odd bet 31D, the red/black bet 31E, the high/low bet 31F, are equivalently converted into the substantial betting points of the corresponding game results 21. For example, if the third dozen of the dozen bets 31C is bet and and the betting amount is “1200”, then after equivalent conversion, the substantial betting points allocated to the numbers 25˜36 of the game results 21 are “100”, respectively.

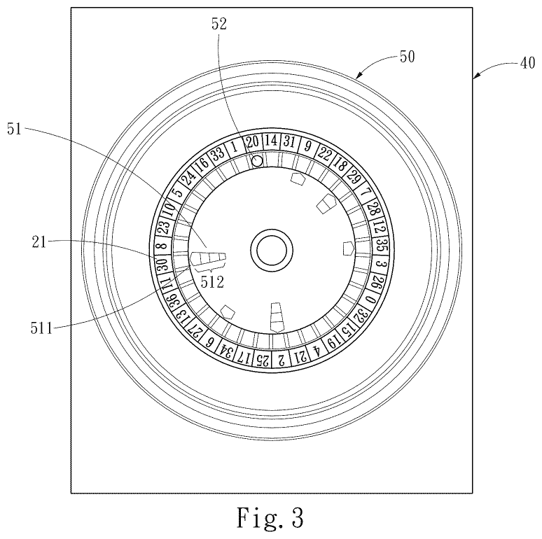

Further refer to FIG. 3, the game processing unit 10 displays a roulette image 50 through the game status display screen 40. The roulette image 50 displays the plurality of game results 21 arranged in a ring, the roulette image 50 displays a colored ball image 52, and the colored ball image 52 is used to display which of the game results 21 is designated.

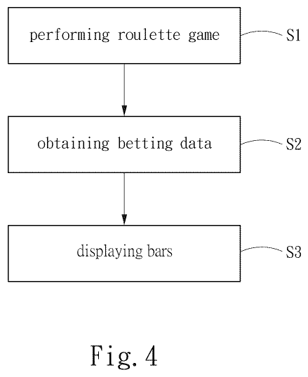

Further refer to FIG. 4, the game processing unit 10 is configured to perform the following step S1, step S2, and Step S3.

Step S1: performing a roulette game, an operation of the roulette game is controlled by generating one of the plurality of game results 21 through the game result generating unit 20.

Step S2: obtaining a betting data, the game processing unit 10 obtains a betting data which is generated by a player betting on a plurality of betting areas 31 within a betting time through the betting interface 30.

Step S3: displaying a plurality of bars, the game status display screen 40 displays a plurality of bars 51 (only depicted in FIG. 3), the plurality of bars 51 show substantial betting points of the plurality of game results 21 through different length, and the substantial betting points are equivalently converted from the betting data. The game processing unit is configured to perform a numerical range classification on numerical values of the substantial betting points of the plurality of game results, so that the substantial betting points of the plurality of game results are arranged from small to large numerical values and classified to belong to a plurality of range groups Pi, wherein i is one of 1, 2, . . . , N, and N is greater than or equal to 3. The substantial betting point with the largest value belongs to the range group PN and is presented by the longest one the plurality of bars 51. The substantial betting point belonging to the range group PN is shown by the bar with the longest length. Each of the plurality of bars 51 is composed of a plurality of patterns 512, and the bar 51 has a corresponding number of the patterns 512 respectively according to the range groups Pi, i=1, 2, . . . , N. In implementation, the plurality of patterns 512 are selected from a group consisting of squares, coin symbols, and ancient Chinese coins with a square hole in a center, and can be freely configured according to preferences of players in various regions.

In one embodiment, the range groups Pi, i=1, 2, . . . , N have an equal group interval D. As a maximum value of the substantial betting points is M, the group interval D is “M/N”, and a numerical value of the substantial betting points of the range groups Pi, i=1, 2, . . . , N is greater than “D*(i−1)”, and less than or equal to “D*i”.

For example, if the substantial betting points of the game results 21 are “100”, “100”, “80” and “60” respectively, the maximum value M=“100”. If N=“4”, then the group interval D=“100/4”=“25”. Therefore, the substantial betting point of the range group P1 is greater than “0” and less than or equal to “25”, the substantial betting point of the range group P2 is greater than “25” and less than or equal to “50”, the substantial betting point of the range group P3 are greater than “50” and less than or equal to “75”, and the substantial betting point of the range group P4 are greater than “75” and less than or equal to “100”. Therefore, the substantial betting points “100”, “80” are classified to belong to the range group P4, and the substantial betting points “60” are classified to belong to the range group P3.

In another embodiment, group intervals D of the range groups Pi, i=1, 2, . . . , N are respectively determined by predetermined settings. In more detail, the group interval D of each of the range groups Pi, i=1, 2, . . . , N is predetermined determined, so the group interval D of each of the range groups Pi, i=1, 2, . . . , N can be set according to preferences of players in different regions. For example, the group interval D of the range group PN can be made the largest. Alternatively, the group intervals D from the range group P1 to the range group PN can be gradually increased.

In one embodiment, numerical values of the substantial betting points belonging to the same range group Pi, i=1, 2, . . . , N are indicated by the corresponding bars 51 with different shades of a color, so as to facilitate the player to further grasp an amount of the substantial betting points.

In one embodiment, the plurality of bars 51 corresponding to the range groups Pi, i=1, 2, . . . , N have colors of different shades respectively, so that the player can quickly make judgments through the colors.

In one embodiment, the roulette image 50 displays the plurality of bars 51 at positions adjacent to the game results 21. In a preferably embodiment, as shown in FIG. 3, each of the plurality of bars 51 has an arrow symbol 511, and the arrow symbol 511 points to the corresponding game result 21. The plurality of bars 51 are located on an inner side of the plurality of game results 21. Or, in another embodiment, the plurality of bars 51 can also be located on an outer side of the plurality of game results 21.

As described above, the plurality of bars 51 correspondingly show the substantial betting points of the adjacent game results 21, and a length of each of the plurality of bars 51 correspondingly shows the range group Pi, i=1, 2, . . . , N the substantial betting points are classified to belong to. In more detail, numerical values of the substantial betting points of the plurality of game results 21 are respectively grouped into one of the range groups Pi, and the different range groups Pi are the plurality of bars 51 with different lengths. Therefore, based on a length of one of the plurality of bars 51, the range group Pi to which a numerical value of the substantial betting points is classified to belong can be quickly known.

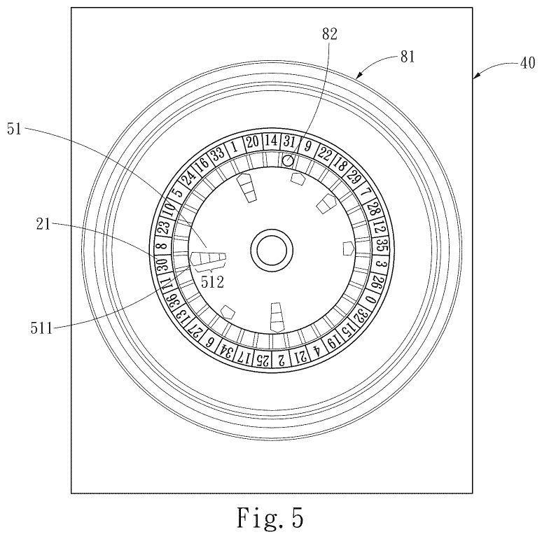

Please refer to FIG. 1 and FIG. 5 together. The invention further comprises an image capturing unit 60, an image recognition unit 70 and an image synthesis processing unit 80 connected to the game processing unit 10. In one embodiment, the game result generating unit 20 is a physical roulette wheel, and the image capturing unit 60 captures a real scene of the game result generating unit 20 to obtain a real-time image and transmits the real-time image to the game processing unit 10. The game processing unit 10 transmits the real-time image to the image recognition unit 70. The image recognition unit 70 identifies and analyzes a position of the real-time image to generate a position information and transmits the position information to the game processing unit 10. The game processing unit 10 transmits the roulette image 50 (as shown in FIG. 3), the real-time image and the position information to the image synthesis processing unit 80, and the image synthesis processing unit 80 generates a virtual-real synthesis image 81 based on the roulette image 50, the real-time image and the position information. Then, the virtual-real synthesis image 81 is transmitted to the game processing unit 10. The game processing unit 10 transmits the virtual-real synthesis image 81 to the game status display screen 40, so that the game status display screen 40 displays the virtual-real synthesis image 81.

In implementation, during the betting time, when the betting data changes, the bars 51 displayed by the roulette image 50 change immediately, and the image synthesis processing unit 80 updates the virtual-real synthesis image 81 in real time. In order to reduce a system load, the image synthesis processing unit 80 can generate the virtual-real synthesis image 81 only after the betting time is over.

In this way, the plurality of bars 51 in the roulette image 50 will be displayed in the virtual-real synthesis image 81, and a physical colored ball 82 of the physical roulette wheel will also be displayed in the virtual-real synthesis image 81 in real time. Therefore, the player can grasp the betting data and the about to be generated game result 21 through the virtual-real synthesis image 81.

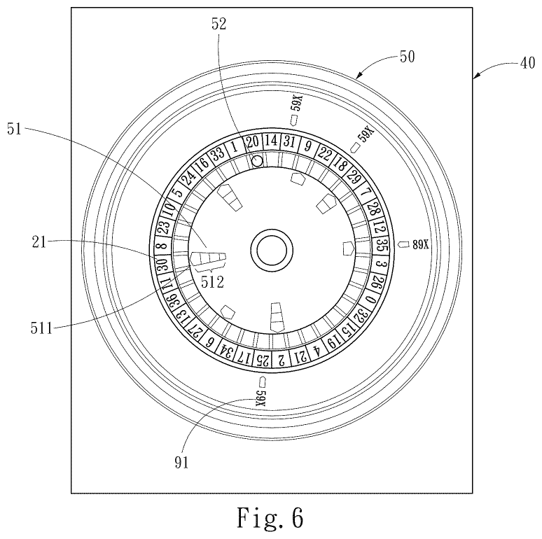

Please refer to FIG. 1, FIG. 2 and FIG. 6 together. In addition, the invention further comprises a random odds generating unit 90 connected to the game processing unit 10. The random odds generating unit 90 generates a random odds 91 according to a probability for each of the betting areas 31 after the betting time of each round of the roulette game ends, and the random odds generating unit 90 transmits the random odds 91 to the game processing unit 10. When the game processing unit 10 receives the random odds 91, the random odds 91 is displayed next to the game results 21 of the roulette image 50. In actual implementation, as shown in FIG. 5, the random odds 91 is located on an inner side of the game results 21. Or, the random odds 91 can also be located on an outer side of the game results 21.

Accordingly, compared with the prior art, the invention at least has following features.

1. The invention first performs grouping for the substantial betting points, so that the substantial betting points are arranged from small to large numerical values and classified to belong to the range groups Pi, and The substantial betting point belonging to the range group PN is shown by the bar with the longest length. Therefore, there will be no issues relating to the inappropriate scale due to the substantial betting points are too small or too large.

2. Since the invention enables a length of each of the bars displayed by the roulette image correspondingly showing the range groups Pi the substantial betting points of the game results are classified to belong to, the player will not have any problem that a length of each of the bars is too short and difficult to interpret, or a length is too long to exceed a boundary of the roulette image and cannot be judged.

3. The bars change in shade of color according to numerical values of the substantial betting points, which can assist the player in making judgments.

4. Real-time positions of the bars and the physical colored ball of the physical roulette wheel are simultaneously displayed in the virtual-real synthesis image, so that the player can grasp the betting data and the about to be generated game result through the virtual-real synthesis image.

What is claimed is:

1. A bet display system for roulette, comprising a game processing unit, a game result generating unit, a betting interface, and a game status display screen, the game processing unit connected to the game result generating unit, the betting interface, and the game status display screen, and the game processing unit being configured to perform the following steps:
controlling an operation of a roulette game by generating one of a plurality of game results through the game result generating unit and displaying a roulette image through the game status display screen;
obtaining a betting data generated by a player betting on a plurality of betting areas within a betting time through the betting interface, and each of the plurality of betting areas corresponding to at least one of the plurality of game results; and
displaying a plurality of bars on the game status display screen, the plurality of bars showing a plurality of substantial betting points of the plurality of game results at different lengths, wherein after equivalently converting the betting data into the plurality of substantial betting points, the game processing unit is configured to perform a numerical range classification on numerical values of the substantial betting points of the plurality of game results, so that the substantial betting points of the plurality of game results are arranged from small to large numerical values and classified to belong to a plurality of range groups Pi, wherein i is one of 1, 2, . . . , N, and N is greater than or equal to 3, and the substantial betting point belonging to the range group PN is shown by the bar with the longest length.

2. The bet display system for roulette as claimed in claim 1, wherein the plurality of bars are composed of a plurality of patterns respectively, and a number of the plurality of patterns of each of the plurality of bars corresponds to the range groups Pi, i=1, 2, . . . , N.

3. The bet display system for roulette as claimed in claim 2, wherein the plurality of patterns are selected from a group consisting of squares, coin symbols, and ancient Chinese coins with a square hole in a center.

4. The bet display system for roulette as claimed in claim 1, wherein group intervals D of the range groups Pi, i=1, 2, . . . , N are equal, a maximum value of the substantial betting points is M, the group intervals D of the range groups Pi, i=1, 2, . . . , N are M/N, a numerical value of the substantial betting points of the range groups Pi, i=1, 2, . . . , N is greater than D*(i−1), and less than or equal to D*i.

5. The bet display system for roulette as claimed in claim 1, wherein group intervals D of the range groups Pi, i=1, 2, . . . , N are respectively determined by predetermined settings, and the group intervals D are different.

6. The bet display system for roulette as claimed in claim 5, wherein the group interval D of the range group PN is the largest.

7. The bet display system for roulette as claimed in claim 5, wherein the group intervals D from the range group P1 to the range group PN is gradually increased.

8. The bet display system for roulette as claimed in claim 1, wherein numerical values of the substantial betting points belonging to the same range group are indicated by the corresponding bars with different shades of colors.

9. The bet display system for roulette as claimed in claim 1, wherein the plurality of bar corresponding to the range group Pi, i=1, 2, . . . , N have colors with different shades.

10. The bet display system for roulette as claimed in claim 1, wherein the roulette image displays the game results arranged in a ring, and the roulette image displays the plurality of bars at positions adjacent to the game results.

11. The bet display system for roulette as claimed in claim 10, wherein each of the plurality of bars comprises an arrow symbol, and the arrow symbol points to the corresponding game result.

12. The bet display system for roulette as claimed in claim 10, wherein the plurality of bars are located on an inner side of the plurality of game results.

13. The bet display system for roulette as claimed in claim 10, wherein the plurality of bars are located on an outer side of the plurality of game results.

14. The bet display system for roulette as claimed in claim 1, wherein the bet display system further comprises an image capturing unit, an image recognition unit and an image synthesis processing unit connected to the game processing unit, wherein the game result generating unit is a physical machine, the image capturing unit is configured to capture a real scene of the game result generating unit to obtain a real-time image and transmit the real-time image to the game processing unit, wherein the game processing unit transmits the real-time image to the image recognition unit, and the image recognition unit is configured to identify and analyze a position of the real-time image to generate a position information and transmitting the position information to the game processing unit, wherein the game processing unit transmits the roulette image, the real-time image and the position information to the image synthesis processing unit, and the image synthesis processing unit is configured to generate a virtual-real synthesis image based on the roulette image, the real-time image and the position information and transmitting the virtual-real synthesis image to the game processing unit, wherein the game processing unit transmits the virtual-real synthesis image to the game status display screen, and the game status display screen is configured to display the virtual-real synthesis image.

15. The bet display system for roulette as claimed in claim 14, wherein during the betting time, when the betting data is changed, the plurality of bars displayed by the roulette image are changed immediately, and the image synthesis processing unit updates the virtual-real synthesis image in real time.

16. The bet display system for roulette as claimed in claim 14, wherein the image synthesis processing unit generates the virtual-real synthesis image only after the betting time is over.

17. The bet display system for roulette as claimed in claim 14, wherein the bet display system further comprises a random odds generating unit connected to the game processing unit, wherein the random odds generating unit is configured to generate a random odds according to a probability for each of the plurality of betting areas after the betting time of each round of the roulette game ends, and the random odds generating unit transmits the random odds to the game processing unit, wherein when the game processing unit receives the random odds, the random odds is displayed next to the plurality of game results of the roulette image.

18. The bet display system for roulette as claimed in claim 17, wherein the random odds is located on an inner side of the plurality of game results.

19. The bet display system for roulette as claimed in claim 17, wherein the random odds is located on an outer side of the game results.
